(19) United States
(12) Patent Application Publication
(10) Pub. No.: US 2007/0183761 A1
(43) Pub. Date: Aug. 9, 2007

(54) IMAGING APPARATUS AND IMAGE PROCESSING APPARATUS

(75) Inventor: Michio KOBAYASHI, Okaya (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/672,208

(22) Filed: Feb. 7, 2007

(30) Foreign Application Priority Data
Feb. 9, 2006 (JP) 2006-032626
Jul. 13, 2006 (JP) 2006-192889

(51) Int. Cl. G03B 17/00

(52) U.S. Cl. 396/52

(57) ABSTRACT

An imaging apparatus that photographs a subject to obtain digital image information includes: a photographing operation detection unit that detects angular rate data in a photographing operation over a predetermined sampling period; a polynomial coefficient calculation unit that approximates the angular rate data over each sampling period detected by the photographing operation detection unit to a polynomial and calculates coefficients of the approximated polynomial; and a coefficient storage unit that stores the coefficients of the polynomial calculated by the polynomial coefficient calculation unit.

### CROSS REFERENCE TO RELATED APPLICATIONS

This application claims priority to Japanese Patent Application Nos. 2006-032626 filed Feb. 9, 2006 and 2006-192889 filed Jul. 13, 2006 which are hereby incorporated by reference herein in their entirety.

### BACKGROUND

1. Technical Field

The present invention relates to an imaging apparatus that photographs a subject to obtain digital image information and an image processing apparatus that corrects the image information imaged by the imaging apparatus so as to restore the image information.

2. Related Art

Known imaging apparatuses include an imaging apparatus which has an exposure time detection unit that detects an exposure time of the imaging apparatus, a blur amount detection unit that detects a blur amount during an exposure operation of the imaging apparatus in a time sequential manner, a period setting unit that sets a detection sampling period of the blur amount according to the exposure time detected by the exposure time detection unit, a blur amount storage unit that stores the sampled blur amount, and a recording unit that records blur amount information stored in the blur amount storage unit in a recording medium, and an image restoring apparatus that restores an image having no blur based on blur amount information recorded in a recording medium (for example, refer to Japanese Patent No. 3152750).

However, in the known example disclosed in Japanese Patent No. 3152750, the blur amount of an imaging apparatus is detected over a set sampling period in a time sequential manner, and the sampled blur amount is stored in the blur amount storage unit. Accordingly, as the set sampling period becomes shorter, a data amount corresponding to the blur amount stored in the blur amount storage unit increases. In particular, when detecting a blur amount from the start of a photographing operation before an exposure operation, the data amount increases even more. Accordingly, blur amount data that is stored together with image data becomes large. As a result, a high-capacity memory is required. Further, since the blur amount detected by the blur amount detection unit is stored as it is, data including white noise is stored and an inverse function is obtained in a discrete manner by using the blur amount including white noise at the time of restoring an image. As a result, white noise components at the time of sampling are included in the inverse function, which causes a restored image to deteriorate.

In addition, a sampling period of the blur amount needs to be changed according to the exposure time, which requires a sampling period setting unit. As a result, the configuration of the apparatus becomes complicated.

### SUMMARY

An advantage of some aspects of the invention is that it provides an imaging apparatus which is capable of greatly reducing a storage amount of blur amount data for image restoration stored in a blur amount storage unit over a predetermined sampling period, is not affected by white noise, and is capable of setting a sampling period of a blur amount without being affected by exposure time, and an image processing apparatus that corrects an image imaged by the imaging apparatus so as to restore the image.

According to a first aspect, an imaging apparatus that photographs a subject to obtain digital image information includes: a photographing operation detection unit that detects angular rate data in a photographing operation over a predetermined sampling period; a polynomial coefficient calculation unit that approximates the angular rate data over each sampling period detected by the photographing operation detection unit to a polynomial and calculates coefficients of the approximated polynomial; and a coefficient storage unit that stores the coefficients of the polynomial calculated by the polynomial coefficient calculation unit.

In the imaging apparatus described above, the angular rate data over the predetermined sampling period detected by the photographing operation detection unit is approximated to the polynomial by using a least-square method, a sequential least-square method, the Kalman filter, or the like. Accordingly, a memory capacity can be set to correspond to coefficients of the polynomial. In addition, an amount of data required to restore an image having no blur can be greatly reduced by accurately detecting a blur amount and a photographing operation, such as a tilt operation and a pan operation. Thus, it is possible to store photographing operation data over the entire photographing operation including before and after an actual exposure operation, which allows the blur amount to be accurately measured. In particular, since the least-square method is used for the polynomial approximation, it is possible to reduce white noise components included in the photographing operation data, and accordingly, sample data closer to actual angular rate data can be obtained.

Further, according to a second aspect, an imaging apparatus that photographs a subject to obtain digital image information includes: a photographing operation detection unit that detects angular rate data in a photographing operation over a predetermined sampling period; a polynomial coefficient calculation unit that approximates the angular rate data over each sampling period detected by the photographing operation detection unit to a polynomial and calculates coefficients of the approximated polynomial; a coefficient storage unit that stores the coefficients of the polynomial calculated by the polynomial coefficient calculation unit; and an image restoring unit that performs correction of the photographing operation based on the coefficients of the polynomial stored in the coefficient storage unit so as to restore an image after the correction.

In the imaging apparatus described above, since the image restoring unit corrects the photographing operation based on the coefficients of the polynomial stored in the coefficient storage unit so as to restore an image after the correction, an image having no blur amount is restored based on the blur amount and a photographing operation, such as a tilt operation or a pan operation, of the imaging apparatus in the form of a polynomial. Accordingly, in addition to the advantage of the imaging apparatus according to the first aspect, a blurred image can be simply restored with high precision and low cost.

In the imaging apparatus described above, preferably, the photographing operation detection unit is configured to include an angular rate sensor.

Also, the blur amount and the photographing operation, such as a tilt operation or a pan operation, can be accurately detected as angular rate.

Further, in the imaging apparatus described above, preferably, the angular rate sensor may be a gyrosensor.

Since the angular rate is detected in the gyrosensor as the blur amount and the photographing operation, such as a tilt operation or a pan operation, the angular rate can be accurately detected.

Furthermore, in the imaging apparatus described above, preferably, the polynomial coefficient calculation unit is configured to approximate a sampling time and the angular rate data to a polynomial by applying either a least-square method or a sequential least-square method so as to calculate the coefficients of the approximated polynomial.

Since the sampling time and the angular rate data are approximated to the polynomial by applying either the least-square method or the sequential least-square method, it is possible to reduce white noise components included in the angular rate data, and accordingly, sample data closer to actual angular rate data can be obtained.

Furthermore, according to a third aspect, an image processing apparatus includes: an imaging apparatus having an imaging unit that photographs a subject to obtain digital image information, a photographing operation detection unit that detects angular rate data in a photographing operation over a predetermined sampling period, a polynomial coefficient calculation unit that approximates the angular rate data over each sampling period detected by the photographing operation detection unit to a polynomial and calculates coefficients of the approximated polynomial, and an information storage unit that stores the coefficients of the polynomial calculated by the polynomial coefficient calculation unit together with the digital image information imaged by the imaging unit; an image restoring unit that performs correction of the photographing operation based on the digital image information and the coefficients of the polynomial stored in the information storage unit of the imaging apparatus so as to restore image information after the correction; and an image information output unit that outputs the image information restored by the image restoring unit.

The angular rate data over the predetermined sampling period detected by the photographing operation detection unit is approximated to the polynomial by using the least-square method, the sequential least-square method, the Kalman filter or the like, in the same manner as in the imaging apparatus according to the first aspect. Accordingly, a memory capacity can be set to correspond to coefficients of the polynomial. In addition, an amount of data required to restore an image having no blur can be greatly reduced by accurately detecting a blur amount and a photographing operation, such as a tilt operation or a pan operation. Thus, it is possible to store photographing operation data over the entire photographing operation including before and after an actual exposure operation, which allows the blur amount to be accurately measured. In particular, since the least-square method is used for the polynomial approximation, it is possible to reduce white noise components included in the photographing operation data, and accordingly, sample data closer to actual angular rate data can be obtained. Moreover, printing or display can be performed by correcting the blur amount and a photographing operation, such as movement traces, with the image restoring unit of the image processing apparatus so as to restore image information that is not affected by the photographing operation and then outputting the restored image information to the image information output unit.

Furthermore, according to a fourth aspect, an image processing apparatus includes: an image restoring unit that performs correction of a photographing operation based on digital image information and coefficients of a polynomial stored in an information storage unit so as to restore image information after the correction, the information storage unit being included in an imaging apparatus having an imaging unit that photographs a subject to obtain the digital image information, a photographing operation detection unit that detects angular rate data in the photographing operation over a predetermined sampling period, a polynomial coefficient calculation unit that approximates the angular rate data over each sampling period detected by the photographing operation detection unit to a polynomial and calculates coefficients of the approximated polynomial, and the information storage unit that stores the coefficients of the polynomial calculated by the polynomial coefficient calculation unit together with the digital image information imaged by the imaging unit; and an image information output unit that outputs the image information restored by the image restoring unit.

In the same manner as in the image processing apparatus according to the third aspect, the image restoring unit restores image information, which is not affected by a photographing operation, based on the coefficients of the polynomial and the digital image information stored in the information storage unit of the imaging apparatus and the restored image information can be printed or displayed in the image information output unit.

In the image processing apparatus described above, preferably, the photographing operation detection unit is configured to include an angular rate sensor.

Also, the blur amount and the photographing operation, such as a tilt operation or a pan operation, can be accurately detected as angular rate.

Furthermore, in the image processing apparatus described above, preferably, the angular rate sensor may be a gyrosensor.

Since the angular rate is detected in the gyrosensor as the blur amount and the photographing operation, such as a tilt operation or a pan operation, the angular rate can be accurately detected.

In addition, in the image processing apparatus described above, preferably, the polynomial coefficient calculation unit is configured to approximate a sampling time and the angular rate data to a polynomial by applying either a least-square method or a sequential least-square method so as to calculate the coefficients of the approximated polynomial.

Since the sampling time and the angular rate data are approximated to the polynomial by applying either the least-square method or the sequential least-square method, it is possible to reduce white noise components included in the angular rate data, and accordingly, sample data closer to actual angular rate data can be obtained.

In addition, in the image processing apparatus described above, preferably, the information storage unit is configured such that the digital image information is stored in an image file after image compression is performed using a JPEG method on the digital image information and the coefficients of the polynomial calculated by the polynomial coefficient calculation unit are added in a header of the image file.

The image compression on the digital image information is performed by using the JPEG method so as to create an image file and the coefficients of the polynomial are added in a header of the image file. Accordingly, since the coefficients of a polynomial can also be stored in an image file, the correspondence between image information and polynomial coefficients can be easily performed.

In addition, in the image processing apparatus described above, preferably, the information storage unit is configured to include a memory card.

Since an image file added with polynomial coefficients is stored in a memory card, data exchange between an imaging apparatus and an image processing apparatus can be easily performed.

Moreover, in the image processing apparatus described above, preferably, the image information output unit is configured to include either a printing apparatus or an image display apparatus.

According to the above, it is possible to restore an image, which is not affected by the photographing operation, in a projector or a printing apparatus including a printer or in an image display apparatus including a television.

### BRIEF DESCRIPTION OF THE DRAWINGS

The invention will be described with reference to the accompanying drawings, wherein like numbers reference like elements.

FIG. 1 is a block diagram schematically illustrating a first embodiment of the invention.

FIG. 2A is a graph illustrating the relationship between a blur amount and a sampling time of image data.

FIG. 2B is a graph illustrating the relationship between a blur amount and a sampling time of image data.

FIG. 3 is a schematic view used to explain an angular rate occurring in a digital still camera.

FIG. 4 is a flow chart illustrating an example of a polynomial approximation process executed by a microcomputer.

FIG. 5 is a flow chart illustrating an example of an image restoring process executed by a microcomputer.

FIG. 6 is a flow chart illustrating an example of a polynomial approximation process executed by a microcomputer in a second embodiment of the invention.

FIG. 7A is an explanatory view illustrating the configuration of a JPEG image file in a third embodiment of the invention.

FIG. 7B is an explanatory view illustrating the configuration of a JPEG image file in a third embodiment of the invention.

FIG. 8 is a table illustrating an example of a data table that can be applied to the third embodiment.

FIG. 9 is a block diagram illustrating a printer that can be applied to the third embodiment.

FIG. 10 is a flow chart illustrating an example of an image printing process executed by a CPU shown in FIG. 9.

### DESCRIPTION OF EXEMPLARY EMBODIMENTS

Hereinafter, embodiments of the invention will be described with reference to the accompanying drawings.

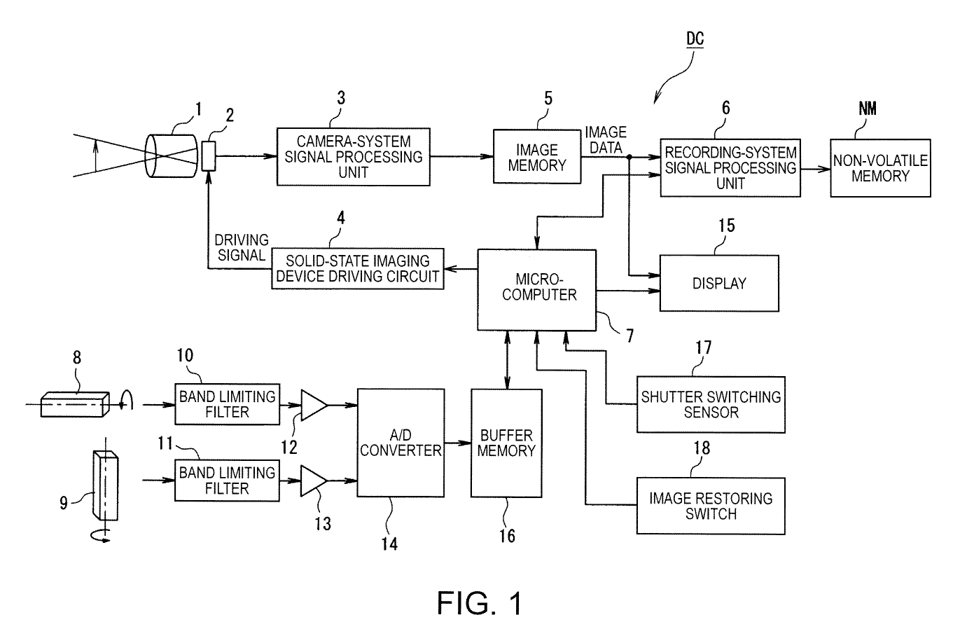

FIG. 1 is a block diagram schematically illustrating an embodiment of the invention. In FIG. 1, ‘DC’ denotes a digital still camera serving as an imaging apparatus which photographs a subject as digital still image information.

In the digital still camera DC, a subject image is imaged on a solid-state imaging device 2, which is disposed at a subsequent stage of a camera lens 1, by the camera lens 1. The solid-state imaging device 2 performs photoelectric conversion by using a driving signal from a solid-state imaging device driving circuit 4. A photoelectrically converted output is supplied to a camera-system signal processing unit 3. The camera-system signal processing unit 3 performs a sampling process and an AGC process on the output, then converts the output into digital data by an A/D conversion process, and then performs a gamma correction process, an encoding process, and the like. Then, the data is input to an image memory 5. Here, the zoom lens 1 and the solid-state imaging device 2 form an imaging unit.

Image data read out from the image memory 5 is supplied to a display 15, such as a liquid crystal monitor or an organic EL display, and at the same time, is output to a recording-system signal processing unit 6. The image data is subjected to JPEG conversion in the recording-system signal processing unit 6 and is then stored in a non-volatile memory NM serving as a coefficient storage unit, such as a DRAM, an SRAM, or a flash memory.

In addition, in order to perform hand shaking (jitter) correction, there are provided vertical and horizontal angular rate sensors 8 and 9, such as a gyrosensor (gyroscope), serving as a blur amount detection unit that detects the Coriolis force when the Coriolis force in the vertical and horizontal directions occurs in a housing of the digital still camera DC. Detection signals output from the vertical and horizontal angular rate sensors 8 and 9 are supplied to band limiting filters 10 and 11 so as to be band-limited. Then, the signals are amplified in amplifiers 12 and 13, are converted to digital signals over a predetermined sampling period by an A/D converter 14, and then are temporarily stored in a buffer memory 16. Then, vertical and horizontal angular rate data stored in the buffer memory 16 is read out by a microcomputer 7 that performs an overall control of the digital still camera DC.

Further, in the microcomputer 7, when a shutter switching signal SS from a shutter switching sensor 17 is input, vertical and horizontal angular rate data, which is stored in the buffer memory 16, while the shutter switching signal is in a shutter open state and for a predetermined period of time before and after the shutter switching signal changes to the shutter open state is read out and coefficients of a polynomial are calculated by performing a polynomial approximation process on the read angular rate data. Then, the calculated coefficients are output to the recording-system signal processing unit 6 at timing when the recording-system signal processing unit 6 reads out the image data from the image memory 5. Then, the calculated coefficients are subjected to signal processing together with the image data in the recording-system signal processing unit 6 and are then stored in the non-volatile memory NM, such as a memory card.

Moreover, in the microcomputer 7, the image data and the coefficients of a polynomial stored in the non-volatile memory NM are read out, and an image restoring process for restoring image data having no blur amount is performed based on the coefficients of the polynomial so as to display the image data having no blur amount on the display 15.

Here, a theoretical background for restoring an image having no blur from blur amount data including a blur amount is as follows.

That is, a blurred image g(x, y) obtained in the case of assuming that a subject f(x, y) moves by α(t) in the x direction and β(t) in the y direction during a period of time from −T/2 to T/2 can be expressed in the following equation 1.

g(x,y)=∫_{-T/2}^{T/2}f(x−α(t),y−β(t))dt Equation 1

If both sides of the equation 1 are Fourier transformed, the following equation 2 is obtained.

G(u,ν)=∫_{∞}^{∞}∫_{∞}^{∞}[∫_{-T/2}^{T/2}f(x−α(t),y−β(t))dt]e^{-j2α(ux+νy)}dxdy Equation 2

The equation 2 can be modified to the following equation 3.

G(u,ν)=F(u,ν)∫_{-T/2}^{T/2}[e^{-j2π(uα(t)+β(t))}]dt Equation 3

The equation 3 can be finally modified to the following equation 4.

G(u,v)=F(u,v)H(u,v) Equation 4

Here, α(t)=p·t,β(t)=q·t,Δt=[−T/2, T/2] Equation 5

Further, H(u, v) can be expressed in the following equation 6.

$$H ( u , v ) = \frac{sin [ π ( u \cdot p + v \cdot q ) Δ t ]}{π ( u \cdot p + v \cdot q )} \qquad Equation 6$$

Assuming that p and q are known in the equation 5, H(u, v) is obtained from the equation 6. Thus, Fourier transform of an image including a blur amount is obtained.

Then, Fourier transform of an original image is obtained by the following equation 7.

F(u,v)=G(u,v)/H(u,v) Equation 7

Hereinbefore, a method of obtaining a subject image f(x, y) has been described when the blurred image g(x, y) is obtained in the case when the subject moves by p pixels in the x direction and q pixels in the y direction during a period of time of Δt.

Furthermore, in order to obtain an image of a subject from a blurred image obtained in the case when the subject moves (p1, q1), (p2, q2), . . . , (pN, qN) during a period of time of Δt, calculation is performed as follows.

$$\begin{matrix}g ( x , y ) = {\int }_{- T / 2}^{T / 2} f ( x - α ( t ) , y - β ( t ) ) d t \\ = {\int }_{0}^{Δ t} f ( x - {p}_{1} t , y - {q}_{1} t ) d t + \\ {\int }_{0}^{Δ t} f ( x - {p}_{1} t - {p}_{2} t , y - {q}_{1} t - {q}_{2} t ) d t + ⋯ + \\ {\int }_{0}^{Δ t} f ( x - {p}_{1} t - {p}_{2} t ⋯ - {p}_{n} t , y - {q}_{1} t - {q}_{2} t ⋯ - {q}_{n} t ) d t\end{matrix} \qquad Equation 8$$

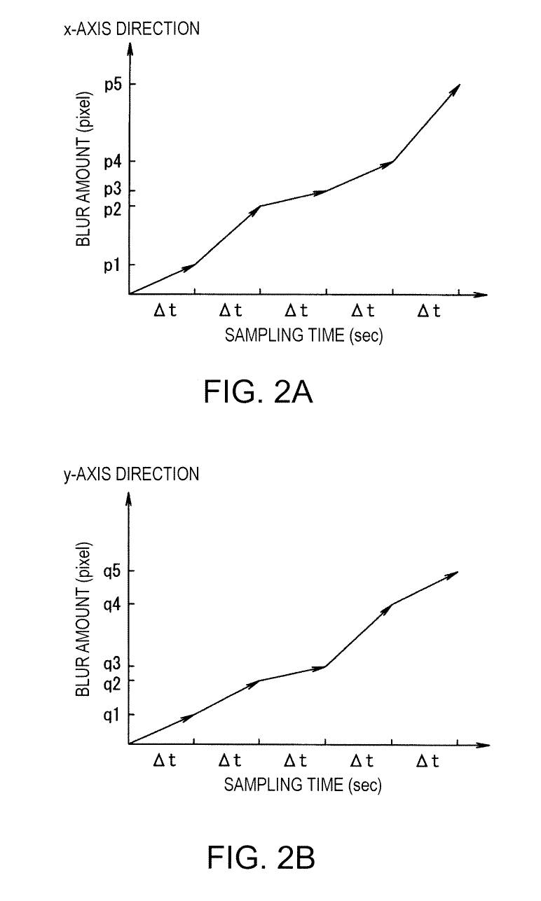

Graphs of a movement amount of a subject in the case described above are shown in FIGS. 2A and 2B.

$$G ( u , v ) = F ( u , v ) {\sum }_{i = 0}^{N - 1} {H}_{i} ( u , v ) \qquad Equation 9$$

Here, Hᵢ(u, v) can be expressed in the following equation 10.

$${H}_{i} ( u , v ) = \frac{Δ t \cdot sin [ π ( u \cdot {\sum }_{k = 1}^{i} {p}_{k} + v \cdot {\sum }_{k = 1}^{i} {q}_{k} ) ]}{π [ u \cdot {\sum }_{k = 1}^{i} {p}_{k} + v \cdot {\sum }_{k = 1}^{i} {q}_{k} ]} \qquad Equation 10$$

Therefore, if the blurred image g(x, y) including a blur amount, an x-direction blur amount pi, and a y-direction blur amount qi are obtained, it is possible to obtain the image f(x, y) of the subject.

In addition, the blur amounts pi and qi can be obtained from measured values of angular rate sensors in the x and y directions, respectively.

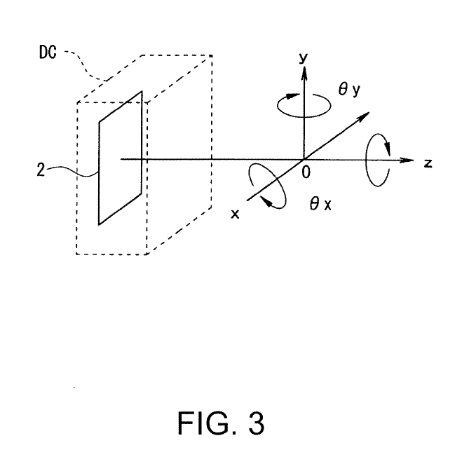

However, in the present embodiment, two angular rate sensor components (angular rate sensors 8 and 9) that detect a variation state of an optical axis direction of the camera lens 1 of the digital still camera correspond to orthogonal vector components within a plane of the solid-state imaging device 2, as shown in FIG. 3. These two angular rate components are denoted as variables θx and θy, as shown in FIG. 3.

By multiplying the angular rate components by correction coefficients λx and λy, it is possible to obtain a blur amount (pixel) of an image in the x-axis or y-axis direction.

Here, the blur amount of an image in the x direction is θy×λx, and the blur amount of an image in the y direction is θx×λy. In this case, the shape of variation of the blur amount obtained from each of the angular rate sensors 8 and 9 is shown in FIGS. 2A and 2B.

Under a state in which angular rate data of each of the angular rate sensors 8 and 9 is sampled at sampling intervals Δt (for example, a predetermined frequency within a range of 40 to 400 Hz) and the sample data is stored in the buffer memory 16 in a time sequential manner, the variation of each angular rate is obtained as a polynomial function of time by using several sample data after a shutter is closed by operating the shutter switching sensor 17. At this time, image data is stored in the image memory 5.

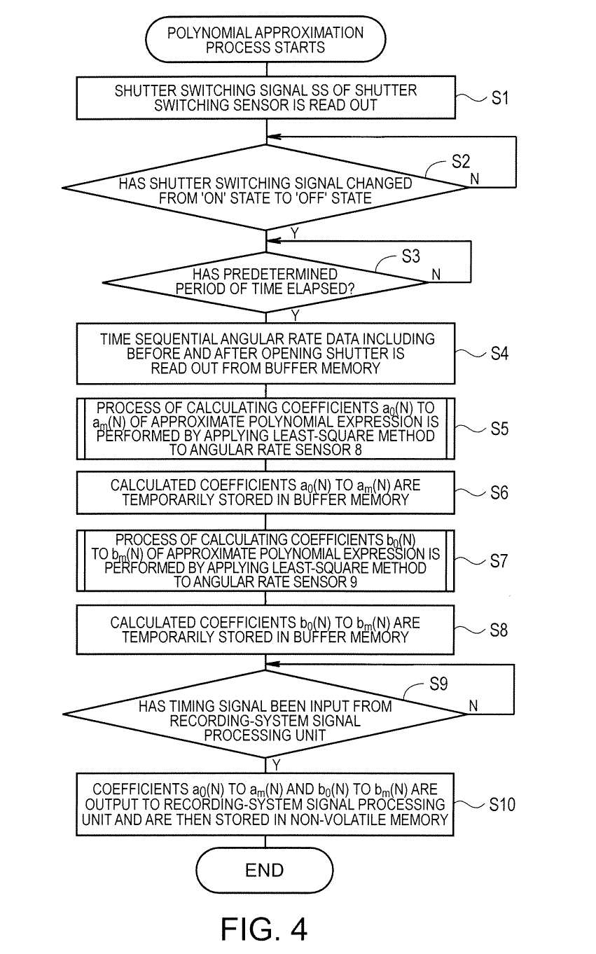

Then, the microcomputer 7 performs the polynomial approximation process, which is shown in FIG. 4, with respect to each angular rate data stored in the buffer memory 16, thereby calculating coefficients a₀ to a_{M}. Then, the calculated coefficients a₀ to a_{M} are stored in the non-volatile memory NM together with the image data stored in the image memory 5.

As shown in FIG. 4, in the polynomial approximation process, first, the shutter switching signal SS detected by the shutter switching sensor 17 is read out. Next, the process proceeds to step S2. In the step S2, it is determined whether or not the read shutter switching signal SS has changed from an ‘ON’ state indicating a shutter open state to an ‘OFF’ state indicating a shutter close state, for example. If it is determined that the shutter switching signal SS is in the ‘ON’ state or the ‘OFF’ state, the process waits until the shutter switching signal SS changes from the ‘ON’ state to the ‘OFF’ state. If it is determined that the shutter switching signal SS changes from the ‘ON’ state to the ‘OFF’ state, the process proceeds to step S3.

In the step S3, it is determined whether or not a predetermined period of time has elapsed after the shutter switching signal SS is turned off. If it is determined that the predetermined period of time has not elapsed, the process waits until the predetermined time elapses. If it is determined that the predetermined period of time has elapsed, the process proceeds to step S4. In the step S4, several or tens of several sample data before the shutter switching signal SS is turned on, sample data while the shutter switching signal SS is in the ‘ON’ state, and several or tens of several sample data after the shutter switching signal SS is turned off are consecutively read out, as angular rate data at the time of a photographing operation, from time sequential data of the vertical and horizontal angular rate data θx and θy stored in the buffer memory 16. Next the process proceeds to step S5.

In the step S5, a coefficient calculation process for obtaining respective read angular rate data θx₁ to θxₘ and θy₁ to θyₘ as a polynomial function of variation of angular rate and time is performed by applying a least-square method to the read angular rate data θx₁ to θxₘ and θy₁ to θyₘ.

In the least-square method, in the case when a measurement set of measuring time and angular rate data of the angular rate sensor 8 is defined as (xᵢ, yᵢ), it is assumed that approximation can be made as follows.

f(a, x)a=(a₀, a₁, . . . , aₘ) Equation 11

Assuming that an error between a predetermined measurement point (xᵢ, yᵢ) and an approximated polynomial is εᵢ, εᵢ can be expressed in the following equation 12.

εᵢ=yᵢ−f(a,x) Equation 12

Assuming that evaluation coefficient is J, the evaluation coefficient J is expressed in the following equation 13.

$$J = {\sum }_{i = 1}^{N} {ɛ}_{i}^{2} = {{\sum }_{i}}^{N} {[ {y}_{i} - f ( a , {x}_{i} ) ]}^{2} \qquad Equation 13$$

The least-square method is to obtain ‘a’ which minimizes the evaluation coefficient J. In order to do so, both sides of the equation 13 are partially differentiated by aₖ and are then put to be zero, the following equation 14 is obtained.

$$\frac{\partial J}{\partial {a}_{k}} = - 2 {\sum }_{i = 1}^{N} [ {y}_{i} - f ( a , {x}_{i} ) ] \frac{\partial f ( a , {x}_{i} )}{\partial {a}_{k}} = 0 \\ ( k = 0 , … , m ) \qquad Equation 14$$

In addition, since f(a, x) can be expressed in the following equation 15 from the equation 11.

f(a,x)=a₀+a₁x+a₂x²+ . . . aₘx^{m} Equation 15

Accordingly, the following equation 16 is obtained.

$$\frac{\partial f ( a , {x}_{i} )}{\partial {a}_{k}} = {x}_{i}^{k} \qquad Equation 16$$

Accordingly, the equation 14 is expressed in the following equation 17.

$${\sum }_{i = 1}^{N} [ {y}_{i} - f ( a , {x}_{i} ) ] {x}_{i}^{k} = 0 ( k = 0 , … , m ) \qquad Equation 17$$

If the equation 17 is calculated to be arranged, the following equation 18 is obtained in the case of m=9.

$$[ \begin{matrix}{\sum }_{i = 1}^{N} {x}_{i}^{0} {\sum }_{i = 1}^{N} {x}_{i}^{1} {\sum }_{i = 1}^{N} {x}_{i}^{2} {\sum }_{i = 1}^{N} {x}_{i}^{3} {\sum }_{i = 1}^{N} {x}_{i}^{4} {\sum }_{i = 1}^{N} {x}_{i}^{5} {\sum }_{i = 1}^{N} {x}_{i}^{6} {\sum }_{i = 1}^{N} {x}_{i}^{7} {\sum }_{i = 1}^{N} {x}_{i}^{8} {\sum }_{i = 1}^{N} {x}_{i}^{9} \\ {\sum }_{i = 1}^{N} {x}_{i}^{1} {\sum }_{i = 1}^{N} {x}_{i}^{2} {\sum }_{i = 1}^{N} {x}_{i}^{3} {\sum }_{i = 1}^{N} {x}_{i}^{4} {\sum }_{i = 1}^{N} {x}_{i}^{5} {\sum }_{i = 1}^{N} {x}_{i}^{6} {\sum }_{i = 1}^{N} {x}_{i}^{7} {\sum }_{i = 1}^{N} {x}_{i}^{8} {\sum }_{i = 1}^{N} {x}_{i}^{9} {\sum }_{i = 1}^{N} {x}_{i}^{10} \\ {\sum }_{i = 1}^{N} {x}_{i}^{2} {\sum }_{i = 1}^{N} {x}_{i}^{3} {\sum }_{i = 1}^{N} {x}_{i}^{4} {\sum }_{i = 1}^{N} {x}_{i}^{5} {\sum }_{i = 1}^{N} {x}_{i}^{6} {\sum }_{i = 1}^{N} {x}_{i}^{7} {\sum }_{i = 1}^{N} {x}_{i}^{8} {\sum }_{i = 1}^{N} {x}_{i}^{9} {\sum }_{i = 1}^{N} {x}_{i}^{10} {\sum }_{i = 1}^{N} {x}_{i}^{11} \\ {\sum }_{i = 1}^{N} {x}_{i}^{3} {\sum }_{i = 1}^{N} {x}_{i}^{4} {\sum }_{i = 1}^{N} {x}_{i}^{5} {\sum }_{i = 1}^{N} {x}_{i}^{6} {\sum }_{i = 1}^{N} {x}_{i}^{7} {\sum }_{i = 1}^{N} {x}_{i}^{8} {\sum }_{i = 1}^{N} {x}_{i}^{9} {\sum }_{i = 1}^{N} {x}_{i}^{10} {\sum }_{i = 1}^{N} {x}_{i}^{11} {\sum }_{i = 1}^{N} {x}_{i}^{12} \\ {\sum }_{i = 1}^{N} {x}_{i}^{4} {\sum }_{i = 1}^{N} {x}_{i}^{5} {\sum }_{i = 1}^{N} {x}_{i}^{6} {\sum }_{i = 1}^{N} {x}_{i}^{7} {\sum }_{i = 1}^{N} {x}_{i}^{8} {\sum }_{i = 1}^{N} {x}_{i}^{9} {\sum }_{i = 1}^{N} {x}_{i}^{10} {\sum }_{i = 1}^{N} {x}_{i}^{11} {\sum }_{i = 1}^{N} {x}_{i}^{12} {\sum }_{i = 1}^{N} {x}_{i}^{13} \\ {\sum }_{i = 1}^{N} {x}_{i}^{5} {\sum }_{i = 1}^{N} {x}_{i}^{6} {\sum }_{i = 1}^{N} {x}_{i}^{7} {\sum }_{i = 1}^{N} {x}_{i}^{8} {\sum }_{i = 1}^{N} {x}_{i}^{9} {\sum }_{i = 1}^{N} {x}_{i}^{10} {\sum }_{i = 1}^{N} {x}_{i}^{11} {\sum }_{i = 1}^{N} {x}_{i}^{12} {\sum }_{i = 1}^{N} {x}_{i}^{13} {\sum }_{i = 1}^{N} {x}_{i}^{14} \\ {\sum }_{i = 1}^{N} {x}_{i}^{6} {\sum }_{i = 1}^{N} {x}_{i}^{7} {\sum }_{i = 1}^{N} {x}_{i}^{8} {\sum }_{i = 1}^{N} {x}_{i}^{9} {\sum }_{i = 1}^{N} {x}_{i}^{10} {\sum }_{i = 1}^{N} {x}_{i}^{11} {\sum }_{i = 1}^{N} {x}_{i}^{12} {\sum }_{i = 1}^{N} {x}_{i}^{13} {\sum }_{i = 1}^{N} {x}_{i}^{14} {\sum }_{i = 1}^{N} {x}_{i}^{15} \\ {\sum }_{i = 1}^{N} {x}_{i}^{7} {\sum }_{i = 1}^{N} {x}_{i}^{8} {\sum }_{i = 1}^{N} {x}_{i}^{9} {\sum }_{i = 1}^{N} {x}_{i}^{10} {\sum }_{i = 1}^{N} {x}_{i}^{11} {\sum }_{i = 1}^{N} {x}_{i}^{12} {\sum }_{i = 1}^{N} {x}_{i}^{13} {\sum }_{i = 1}^{N} {x}_{i}^{14} {\sum }_{i = 1}^{N} {x}_{i}^{15} {\sum }_{i = 1}^{N} {x}_{i}^{16} \\ {\sum }_{i = 1}^{N} {x}_{i}^{8} {\sum }_{i = 1}^{N} {x}_{i}^{9} {\sum }_{i = 1}^{N} {x}_{i}^{10} {\sum }_{i = 1}^{N} {x}_{i}^{11} {\sum }_{i = 1}^{N} {x}_{i}^{12} {\sum }_{i = 1}^{N} {x}_{i}^{13} {\sum }_{i = 1}^{N} {x}_{i}^{14} {\sum }_{i = 1}^{N} {x}_{i}^{15} {\sum }_{i = 1}^{N} {x}_{i}^{16} {\sum }_{i = 1}^{N} {x}_{i}^{17} \\ {\sum }_{i = 1}^{N} {x}_{i}^{9} {\sum }_{i = 1}^{N} {x}_{i}^{10} {\sum }_{i = 1}^{N} {x}_{i}^{11} {\sum }_{i = 1}^{N} {x}_{i}^{12} {\sum }_{i = 1}^{N} {x}_{i}^{13} {\sum }_{i = 1}^{N} {x}_{i}^{14} {\sum }_{i = 1}^{N} {x}_{i}^{15} {\sum }_{i = 1}^{N} {x}_{i}^{16} {\sum }_{i = 1}^{N} {x}_{i}^{17} {\sum }_{i = 1}^{N} {x}_{i}^{18}\end{matrix} ] [ \begin{matrix}{a}_{0} ( N ) \\ {a}_{1} ( N ) \\ {a}_{2} ( N ) \\ {a}_{3} ( N ) \\ {a}_{4} ( N ) \\ {a}_{5} ( N ) \\ {a}_{6} ( N ) \\ {a}_{7} ( N ) \\ {a}_{8} ( N ) \\ {a}_{9} ( N )\end{matrix} ] = [ \begin{matrix}{\sum }_{i = 1}^{N} {y}_{i} {x}_{i}^{0} \\ {\sum }_{i = 1}^{N} {y}_{i} {x}_{i}^{1} \\ {\sum }_{i = 1}^{N} {y}_{i} {x}_{i}^{2} \\ {\sum }_{i = 1}^{N} {y}_{i} {x}_{i}^{3} \\ {\sum }_{i = 1}^{N} {y}_{i} {x}_{i}^{4} \\ {\sum }_{i = 1}^{N} {y}_{i} {x}_{i}^{5} \\ {\sum }_{i = 1}^{N} {y}_{i} {x}_{i}^{6} \\ {\sum }_{i = 1}^{N} {y}_{i} {x}_{i}^{7} \\ {\sum }_{i = 1}^{N} {y}_{i} {x}_{i}^{8} \\ {\sum }_{i = 1}^{N} {y}_{i} {x}_{i}^{9}\end{matrix} ] . \qquad Equation 18$$

By solving the equation 18 in order to obtain aᵢ(N) (i=0, . . . , 9), it is possible to obtain y=f(a, x) a=(a₀, a₁, . . . , a₉).

Subsequently, the process proceeds to step S6. In the step S6, ten coefficients a₀(N) to a₉(N) calculated as described above are stored in the buffer memory 16. Next, the process proceeds to step S7. In the step S7, the coefficient calculation process described above is also performed on the angular rate sensor 9 so as to calculate ten coefficients b₀(N) to b₉(N). Next, the process proceeds to step S8. In the step S8, the calculated coefficients b₀(N) to b₉(N) are stored in the buffer memory 16. Next, he process proceeds to step S9.

In the step S9, it is determined whether or not a timing signal for reading out image data of the image memory 5 has been input from the recording-system signal processing unit 6. If it is determined that the timing signal is not input, the process waits until the timing signal is input. On the other hand, if it is determined that the timing signal has been input, the process proceeds to step S10. In the step S10, the coefficients a₀(N) to a₉(N) and b₀(N) to b₉(N) of the angular rate sensors 8 and 9 stored in the buffer memory 16 are output to the recording-system signal processing unit 6. The recording-system signal processing unit 6 adds the coefficients a₀(N) to a₉(N) and b₀(N) to b₉(N) of the angular rate sensors 8 and 9 to image data and then the image data is stored in the non-volatile memory NM, completing the polynomial approximation process.

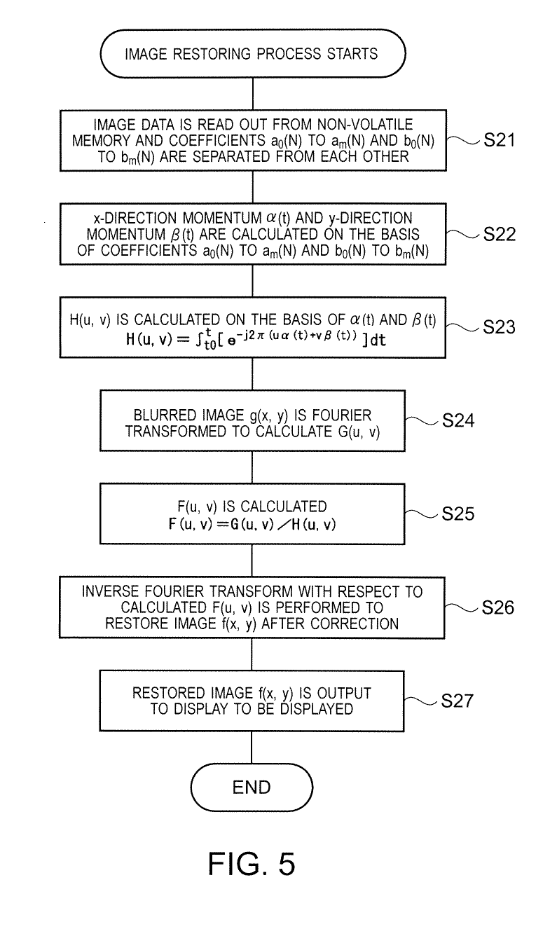

Moreover, in the microcomputer 7, image data to be restored is selected from the image data stored in the non-volatile memory NM and when an image restoring request is input by turning on a switch signal of an image restoring switch 18, an image restoring process shown in FIG. 5 is performed.

In the image restoring process, first, in step S21, the coefficients a₀(N) to a₉(N) and b₀(N) to b₉(N) of approximate polynomials of the angular rate sensors 8 and 9 added to the image data are separated from each other. Next, the process proceeds to step S22. In the step S22, x-direction momentum α(t) and y-direction momentum β(t) are calculated based on the coefficients a₀(N) to a₉(N) and b₀(N) to b₉(N)

α(t)=θy(t)·λx=a₀+a₁x+a₂x²+ . . . a₉x⁹ Equation 19

β(t)=θx(t)·λy=b₀+b₁x+b₂x²+ . . . bₚx⁹ Equation 20

Here, in the equations 19 and 20, polynomials of the angular rate sensors 8 and 9 obtained in the method described above are assumed as follows.

θₓ(t)=I(t)

θ_{y}(t)=m(t) Equation 21

At this time, a variation amount of an angle in each direction can be expressed as follows.

θₓ(t)=∫ₜ₀^{t}I(t)dt

θ_{y}(t)=∫ₜ₀^{t}m(t)dt Equation 22

Then, the process proceeds to step S23. In the step S23, an operation of the following equation 23 is performed based on the calculated movement amount α(t) and β(t), thereby calculating H(u, v).

H(u,ν)=∫ₜ₀^{t}[e^{-j2π(uα(t)+νβ(t))}]dt Equation 23

Subsequently, the process proceeds to step S24. In the step S24, a blurred image g(x, y) including a blur amount stored in the non-volatile memory NM is Fourier transformed to obtain G(u, v). Next, the process proceeds to step S25. In the step S25, an operation expressed by following Equation 24 is performed to calculate F(u, v).

F(u,v)=G(u,v)/H(u,v) Equation 24

Then, the process proceeds to step S26. In the step S26, inverse Fourier transform with respect to the calculated F(u, v) is performed, such that it is possible to restore the image f(x, y) after blur correction.

Thereafter, the process proceeds to step S27. In the step S27, the restored image f(x, y) is output to the display 15 so as to restore an image having no blur.

Here, in the polynomial approximation process shown in FIG. 4, the process in the step S4 and the angular rate sensors 8 and 9 correspond to a blur amount detection unit, the processes in the steps S5 and S7 correspond to a polynomial coefficient calculation unit, and the process in the step S10 and the non-volatile memory NM correspond to a coefficient storage unit. In addition, the image restoring process in FIG. 5 corresponds to an image restoring unit.

Next, an operation of the first embodiment will be described.

First, a shutter speed is calculated based on exposure photometrically measured in an exposure system by pressing a release button (not shown) in a state in which the camera lens 1 of the digital still camera DC is positioned toward a subject, and an image is projected onto the solid-state imaging device 2 through the camera lens 1 when the shutter operates at the calculated shutter speed.

Image information projected onto the solid-state imaging device 2 is sequentially read out by a driving signal from the solid-state imaging device driving circuit 4 and is then subjected to predetermined signal processing in the camera-system signal processing unit 3 so as to be stored as image data in the image memory 5. The image data stored in the image memory 5 is supplied to the display 15 to be displayed. The image data displayed on the display 15 is image data including a blur amount, and a level of the blur amount can be determined based on the displayed image data.

At this time, by an operation of the shutter, the polynomial approximation process shown in FIG. 4 is performed in the microcomputer 7. In the polynomial approximation process, if the shutter switching signal SS, which is inverted from an ‘ON’ state to an ‘OFF’ state when the shutter is closed from a state where the shutter is open by the shutter switching sensor 17, is input to the microcomputer 7, consecutive angular rate data θx₀ to θx_{N} and θy₁ to θy_{N} are read out from the buffer memory 16 at a point of time when a predetermined period of time has elapsed from the input time, that is, at a point of time when the time, at which angular rate data corresponding to several samples set by the A/D converter 14 among the angular rate data of the angular rate sensors 8 and 9 is stored in the buffer memory 16, has elapsed. The consecutive angular rate data θx₀ to θx_{N} and θy₁ to θY_{N} corresponds to several samples before the shutter changes to an open state, samples while the shutter is in the open state, and several samples after the shutter is closed.

Then, the coefficients a₀(N) to a₉(N) and b₀(N) to b₉(N) of approximate polynomials are calculated based on the read angular rate data θx₀ to θx_{N} and θy₁ to θy_{N} and are then temporarily stored in the buffer memory 16. Then, by supplying the coefficients a₀(N) to a₉(N) and b₀(N) to b₉(N) to the recording-system signal processing unit 6 at a timing when the recording-system signal processing unit 6 reads out the image data stored in the image memory 5, the coefficients a₀(N) to a₉(N) and b₀(N) to b₉(N) are added to the image data. Then, the image data is subjected to JPEG conversion or the like and is then stored in the non-volatile memory NM.

When the image restoring switch 18 is turned on under a state in which the image data is stored in the non-volatile memory NM and blurred image data including a blur amount is displayed on the display 15, the image restoring process shown in FIG. 5 is performed in the microcomputer 7.

Thus, the coefficients a₀(N) to a₉(N) and b₀(N) to b₉(N) of the polynomials added to the image data stored in the non-volatile memory NM are separated from each other, and operations of the equations 19 and 20 using the coefficients a₀(N) to a₉(N) and b₀(N) to b₉(N) are performed to calculate the x-direction momentum α(t) and the y-direction momentum β(t) (step S22).

Subsequently, an operation of the equation 21 is performed on the calculated momentum α(t) and β(t) so as to calculate H(u, v) (step S23). Then, the blurred image g(x, y) including the blur amount stored in the non-volatile memory NM is Fourier transformed to obtain G(u, v). Then, an operation of the equation 22 is performed to calculate F (u, v) (step S25). The image f(u, v) having no blur after blur correction can be restored by performing inverse Fourier transform on the calculated F (u, v) and an image having no blur can be restored by outputting the image f(u, v) to the display 15.

As described above, in the first embodiment, the coefficients a₀(N) to a₉(N) and b₀(N) to b₉(N) of polynomial function of variation of angular rate and time are calculated with respect to consecutive angular rate data θx₁′ to θx_{N}′ and θy₁′ to θy_{N}′ which corresponds to sample data while a shutter is in an open state and several samples before and after the shutter changes to an open state, the calculated coefficients a₀(N) to a₉(N) and b₀(N) to b₉(N) are added to image data, and the image data is subjected to the JPEG conversion or the like and is then stored in the non-volatile memory NM. As a result, since only the coefficients a₀(N) to a₉(N) and b₀(N) to b₉(N) are sufficient as data required to restore an image, it is possible to greatly reduce required memory capacity.

Furthermore, in the case of restoring image data with no blur, the x-direction momentum α(t) and the y-direction momentum β(t) are calculated based on the coefficients a₀(N) to a₉(N) and b₀(N) to b₉(N), H(u, v) is calculated based on the x-direction momentum α(t) and the y-direction momentum β(t), and blurred image data g(u, v) including the blur amount stored in the non-volatile memory NM is Fourier transformed to obtain G(u, v). Accordingly, F(u, v) can be obtained by using the equation 22 and the image f(x, y) with no blur after blur correction can be obtained by performing inverse Fourier transform on the F(u, v). As a result, image data having no blur amount can be accurately restored.

Furthermore, since the coefficients a₀(N) to a₉(N) and b₀(N) to b₉(N) are calculated by applying the least-square method, white noise is reduced. Accordingly, it is possible to obtain sample data much closer to actual angular rate data.

In addition, angular rate data corresponding to several samples before photographing starts and several samples after the photographing is completed is acquired and an approximate polynomial is created by using the data. Accordingly, it is possible to accurately estimate angular rate data before and after photographing and before and after completion of the photographing. Since the polynomial approximation is performed as described above, it is not necessary to synchronize shutter timing and timing of gyro-sampling with each other if sampling time information and shutter timing information at the time of the polynomial approximation. In addition, an inverse function of blur can be expressed as a continuous function of a polynomial. As a result, the inverse function can be simply calculated and an accurate inverse function can be obtained without depending on sample rates of the angular rate sensors 8 and 9.

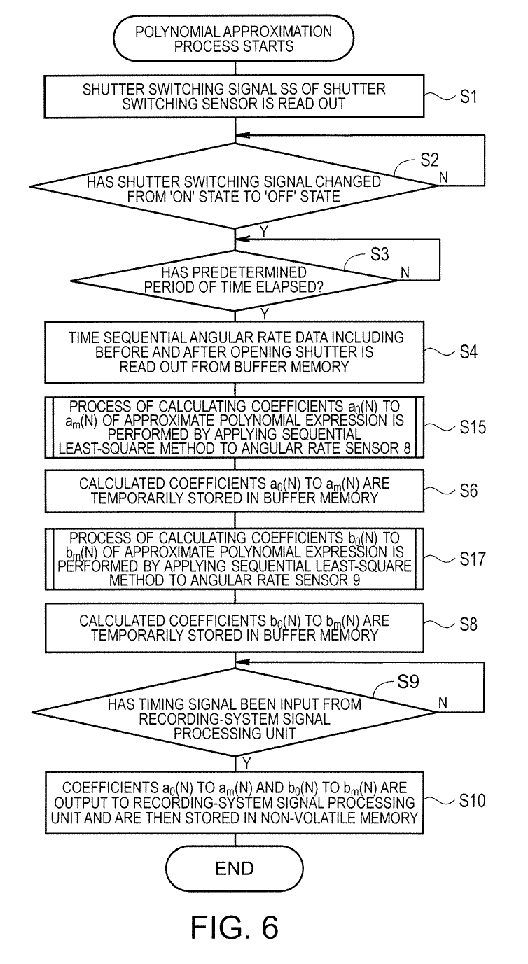

Next, a second embodiment of the invention will be described with reference to FIG. 6.

In the second embodiment, a polynomial approximation process performed in the microcomputer 7 is shown in FIG. 6. Referring to FIG. 6, in the process shown in FIG. 4 in the first embodiment, the coefficient calculation process in the step S5 changes to step S15 in which coefficients α₀(N) to a₉ (N) are calculated based on angular rate data θx₁ to θx_{N} by applying a sequential least-square method. Similarly, the coefficient calculation process in the step S7 changes to step S17 in which coefficients b₀(N) to b₉(N) are calculated based on angular rate data θy₁ to θy_{N} by applying the sequential least-square method. Except for the steps S15 and S17, the polynomial approximation process in FIG. 6 in the second embodiment is the same as that in FIG. 4. Therefore, the same processes as in FIG. 4 are denoted by the same step numbers, and a detailed description thereof will be omitted.

That is, in the coefficient calculation process in the step S15, the following equations 26 to 28 are used, assuming the following equation 25 in the equation 18 using the least-square method.

$$\begin{matrix}{f}_{N}^{k} = {\sum }_{i = 1}^{N} {x}_{i}^{k} ( k = 0 , 1 , … , m ) \\ {g}_{N}^{k} = {\sum }_{i = 1}^{N} {y}_{i} {x}_{i}^{k} ( k = 0 , 1 , … , m ) & Equation 25 \\ F ( N ) = [ \begin{matrix}{f}_{N}^{0} & {f}_{N}^{1} & ⋯ & {f}_{N}^{m} \\ {f}_{N}^{1} & {f}_{N}^{2} & ⋯ & {f}_{N}^{m - 1} \\ ⋮ & ⋯ & ⋱ & ⋮ \\ {f}_{N}^{m} & {f}_{N}^{m + 1} & ⋯ & {f}_{N}^{2 m}\end{matrix} ] & Equation 26 \\ A ( N ) = [ \begin{matrix}{a}_{0} ( N ) \\ {a}_{1} ( N ) \\ ⋮ \\ {a}_{m} ( N )\end{matrix} ] & Equation 27\end{matrix}$$

Accordingly, the equation 8 can be expressed as follows.

F(N)A(N)=G(N)

F(N)=F(N−1)+X(N)(X(N)=[x_{N}⁰ x_{N}¹ . . . x_{N}ⁿ]^{T})

G(N)=G(N−1_{—}+yₙX(N) Equation 29

From the equation 29, the following equation 30 is obtained.

A(N)=F⁻¹(N)F(N−1)A(N−1)+y_{N}F⁻¹(N)X(N) Equation 30

By using the equations 29 and 30, it is possible to obtain coefficients of a polynomial in a sequential manner. This is the sequential least-square method.

That is, estimated coefficients at an N-th point of time are obtained only with modification based on estimated coefficients at an (N−1)-th point of time and N-th data. Based on the equation 28, coefficients of a polynomial can be obtained in the sequential manner. At this time, it is necessary to set initial values F(0) and A(0) beforehand.

Here, in the case of obtaining the polynomial by the use of the least-square method as described in the first embodiment, all data of ‘N’ sets of (x₁, y₁) are first stored in the buffer memory 16 and then simultaneous equations shown in the equation 18 are solved. Accordingly, for example, assuming that N=5000, memory capacity for temporarily storing 5000 sets is needed. However, in the case of applying the sequential least-square method, assuming that m=9, memory capacity corresponding to ‘m×3=27’ is sufficient. As a result, it is possible to more reduce the required memory capacity.

Further, in the first and second embodiments, a case has been described has been described in which the non-volatile memory NM is applied and image data including a blur amount, to which the coefficients a₀(N) to a₉(N) and b₀(N) to b₉(N) are added, is subjected to JPEG conversion and is then stored in the non-volatile memory NM. However, the invention is not limited thereto. For example, image information may be image-compressed by the JPEG conversion and the coefficients a₀(N) to a₉(N) and b₀(N) to b₉(N) of the polynomial may be recorded in a user comment tag within Exif IFD of a JPEG file obtained by the image compression. Alternatively, image data to which the coefficients a₀(N) to a₉(N) and b₀(N) to b₉(N) are added may be directly stored by using a hard disc or a RAM as an image RAM or may be stored after the JPEG conversion.

Furthermore, in the first and second embodiments, a case has been described has been described in which the polynomial approximation process and the image restoring process are performed in the microcomputer 7. However, the polynomial approximation process and the image restoring process may be performed in separate microcomputers, respectively.

In addition, in the first and second embodiment, a case of calculating a blur amount from angular rate data has been described. However, the invention is not limited thereto. For example, by detecting photographing operations, such as tilt or pan, of an imaging apparatus from angular rate data, approximating movement traces of the imaging apparatus in a polynomial, and storing information on the movement traces in the non-volatile memory NM in the form of coefficients of a polynomial, it is possible to store the movement traces of the imaging apparatus with a small amount of memory capacity. Based on the movement traces and the blur amount, the blur correction can be accurately performed and image correction in the case of tilt or pan can be performed.

In addition, in the first and second embodiment, a case has been described in which the invention is applied to the digital still camera DC. However, the invention is not limited thereto. For example, the invention may be applied to a mobile phone having a camera, which photographs image data where blur occurs, and a portable apparatus having a camera function.

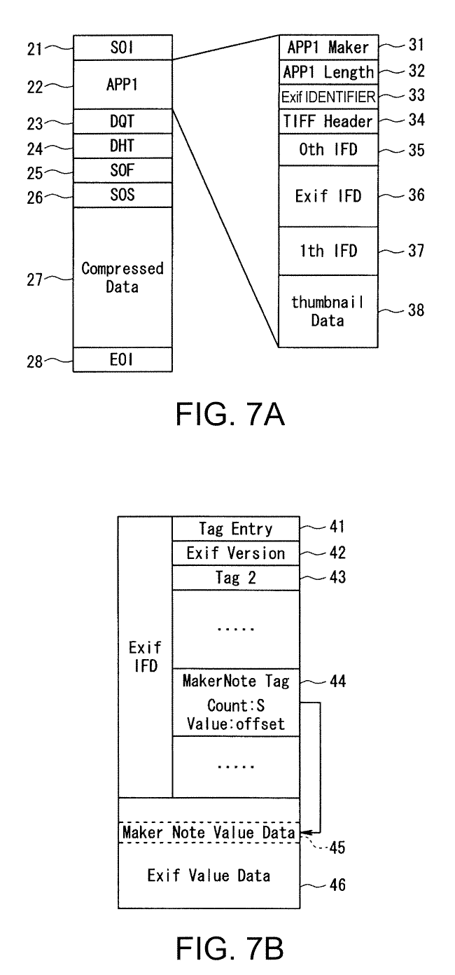

Next, a third embodiment of the invention will be described with reference to FIGS. 7A and 7B, 8, and 9.

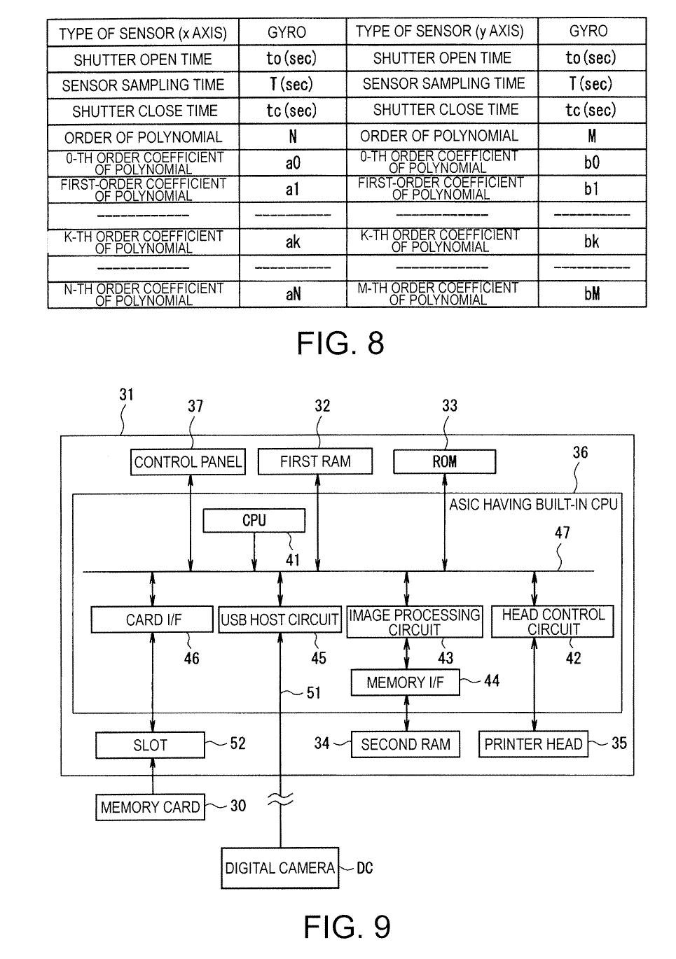

In the third embodiment, a memory card 30 is used as the non-volatile memory NM of the digital still camera DC, and image information is stored in the memory card 30 after performing the JPEG conversion on the image information. In addition, a photographing operation storage table, which is stored with photographing operation data shown in FIG. 8, is stored in hierarchical user tag within Exif IFD of the JPEG image file.

Here, in the JPEG image file, SOI (start of image segment) 21 indicating the start of a JFIF (JPEG file interchange format) file, which is a format file for image data exchange using a JPEG compression method, is disposed at an uppermost layer of the data configuration, as shown in FIG. 7A.

APP1 (application layer 1) 22 serving as a header, which will be described later, is disposed below the SOI 21. DQT (define quantization table segment) 23, which is a quantization table segment where quantization factors for quantizing image data are defined, is disposed below the APP1 22.

DHT (define Huffman table segment) 24, which is a segment where correspondence between variable-length code and fixed-length code in the Huffman code method is defined, is disposed below the DQT 23.

SOF (start of frame type segment) 25, which is a segment indicating data coded in the Huffman code method, is disposed below the DHT 24.

Image data coded in the Huffman code method and SOS (start of scan segment) 26, which is a segment occupying most of the header file, are disposed below the SOF 25.

Data corresponding to entropy coding data in the JPEG standard, that is, Compressed Data 27 serving as image data is disposed below the SOS 26.

EOI (end of image segment), which is a segment indicating the end of the JFIF file, is disposed below the Compressed Data 27.

Furthermore, in the configuration of the APP1 22, APP1 Marker 31, which is a marker indicating the start of an application layer, is disposed at an uppermost layer, and APP1 Length 32, which is data indicating the byte number of field subsequent to the marker, is disposed below the APP1 Marker 31.

In addition, Exif (exchangeable image file format) identifier 33, which is image file format standard for a digital still camera, is disposed below the APP1 Length 32. Moreover, below the Exif identifier 33, there are disposed IFD (image file directory), which is one of the image file formats and in which locations stored with information are collected with information tags attached to data, and TIFF (tagged image file format) Header 34 having actual data are disposed.

In addition, 0th IFD 35 where additional information on a main image that is compressed is recorded is disposed below the TIFF Header 34, and Exif IFD 36 for recording the main image that is compressed is disposed below the 0th IFD 35.

Moreover, 1st IFD 37 where additional information on a thumbnail image is recorded is disposed below the Exif IFD 36, and thumbnail Data 38 for recording the thumbnail image is disposed below the 1st IFD 37.

Further, in the configuration of the Exif IFD 36, Tag Entry 41 is disposed at an uppermost layer, and tag information including Exif Version 42 and Tag2 43 is hierarchized, as shown in FIG. 7B. Among the hierarchized tag information, Maker Note Tag 44 is disposed. The Maker Note Tag 44 is stored with Count: S/Value: offset as a pointer indicating the position of Maker Note Value Data 45.

The Maker Note Value Data 45 is data that is unique for each maker and is positioned within Exif Value Data 46. The Maker Note Value Data 45 includes a photographing operation storage table in which photographing operation data shown in FIG. 8 is included in hierarchized user tag information formed within the Maker Note Value Data 45.

As shown in FIG. 8, the photographing operation storage table includes type of sensor=gyro, shutter OPEN time=to (sec), sensor sampling time=T (sec), shutter CLOSE time=tc (sec), order of polynomial=N, 0-th order coefficient of polynomial=a₀, first-order coefficient of polynomial=a₁, . . . , K-th order coefficient of polynomial=a_{K}, . . . , N-th order coefficient of polynomial=a_{N}, with respect to an X axis. Similarly, with respect to a Y axis, the photographing operation storage table includes type of sensor=gyro, shutter OPEN time=to (sec), sensor sampling time=T (sec), shutter CLOSE time=tc (sec), order of polynomial=M, 0-th order coefficient of polynomial=b₀, first-order coefficient of polynomial=b₁, . . . , K-th order coefficient of polynomial=b_{K}, . . . , M-th order coefficient of polynomial=b_{M}.

Furthermore, in the third embodiment, for example, a stand-alone printer 31 serving as an image processing apparatus is provided, as shown in FIG. 9. The printer 31 includes a first RAM 32, a ROM 33, a second RAM 34, a printer head 35, and an ASIC 36 having a built-in CPU. The first RAM 32 is stored with data (for example, image data) directly read from various storage mediums or a digital camera. The ROM 33 is stored with a control program necessary for a CPU 41, which will be described later, to execute processing. In the present embodiment, an image forming program is stored in the ROM 33. The second RAM 34 is used as a working memory when the CPU 41 executes processing. For example, the second RAM 34 is used as a buffer that temporarily stores image data (for example, print image data) received from a digital camera.

The printer head 35 is provided at a lower end of a carriage (not shown) that reciprocates in the main running direction (direction perpendicular to a paper feed direction). The printer head 35 has a plurality of nozzles for various colors on a surface opposite to a carrying path of printing paper. The printer head 35 reciprocates in the main operation direction based on control of a head control circuit 42, which will be described later, and discharges ink droplets having respective colors from nozzles corresponding to the colors, thereby forming an image on printing paper that is fed.

The ASIC 36 having a built-in CPU includes a CPU 41, the head control circuit 42, an image processing circuit 43, a memory interface circuit (memory I/F) 44, a USB host circuit 45, and a card interface circuit (card I/F) 46 which are connected to one another through an internal bus 47. In addition, the first RAM 32, the ROM 33, and a control panel 37 described in the first embodiment are connected to the internal bus 47.

The CPU 41 reads out a program stored in the ROM 33 and executes processing according to the program, thereby performing an overall control on the printer 31. For example, the CPU 41 performs a control on image forming processing, color conversion processing, halftone processing, and microwave processing in the image processing circuit 43, which will be described later, or performs a driving control on a motor of a carriage in the head control circuit 42.

The image processing circuit 43 performs an image restoring process of restoring image information with no blur by making blur correction on image data stored in the first RAM 32 based on angular rate data at the time of photographing, which will be described later, and stores the image information obtained by performing the image restoring process in the second RAM 34.

The head control circuit 42 controls driving of the motor of the carriage that causes the printer head 35 to reciprocate and controls discharge of ink droplets or an amount of ink droplets to be discharged based on print data, corresponding to respective colors, generated in the image processing circuit 43. The USB host circuit 45 is connected to, for example, a digital camera or an external storage device serving as a USB device through a cable 51 and performs two-way data communication with the digital camera or the like based on USB standard according to the control of the CPU 41.

The card I/F 46 functions as an interface circuit when the memory card 30 as a recording medium is mounted in a slot 52 and converts a JPEG image file stored in the recording medium into data, which can be processed in the printer 31, based on the control of the CPU 41.

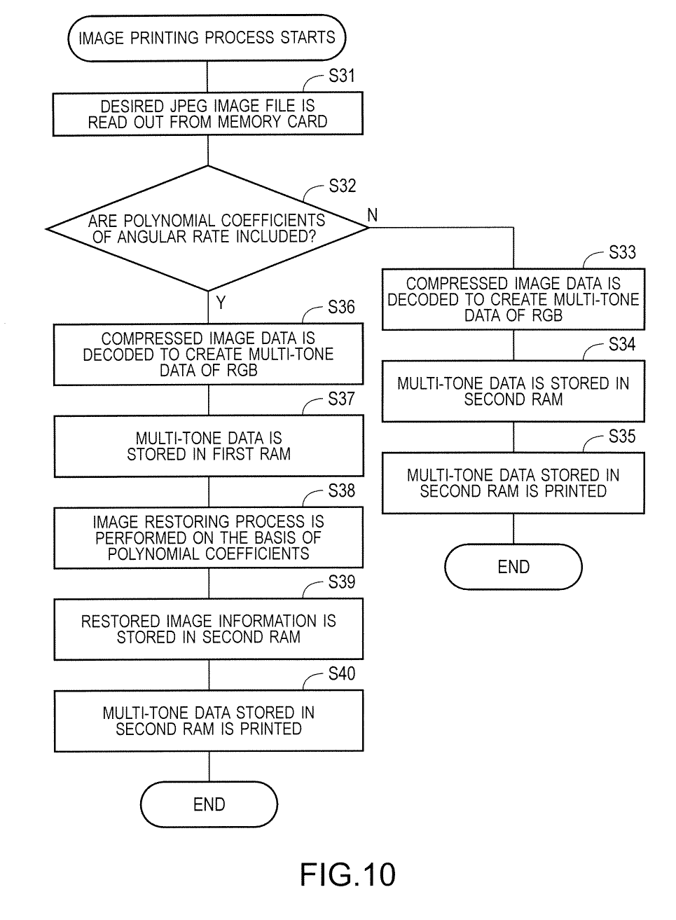

In addition, the CPU 41 executes an image printing process shown in FIG. 10.

In the image printing process, first, in step S31, a desired JPEG image file is read out from JPEG image files stored in the memory card 30 mounted in the slot 52. Next, the process proceeds to step S32. In the step S32, it is determined whether or not coefficients a₀ to a_{N} and b₀ to b_{M} of polynomial of angular rate are included in the read JPEG image file. If it is determined that the coefficients a₀ to a_{N} and b₀ to b_{M} of polynomial of angular rate are not included in the read JPEG image file, the process proceeds to step S33. In the step S33, a decoding process of uncompressing compressed image data stored in the JPEG image file is performed to create multi-tone data of RGB. Next, the process proceeds to step S34. In the step S34, the multi-tone data of RGB after the decoding process is stored in the second RAM 34 through the image processing circuit 43. Next, the process proceeds to step S35. In the step S35, the multi-tone data of RGB stored in the second RAM 34 is transmitted to the printer head 35 through the image processing circuit 43 and the head control circuit 42 and then a printing process of printing image data is performed, returning to the step S31.

On the other hand, in the step S32, if it is determined that the coefficients a₀ to a_{N} and b₀ to b_{M} of polynomial of angular rate are included in the read JPEG image file, the process proceeds to step S36. In the step S36, a decoding process of uncompressing compressed image data stored in the JPEG image file is performed to create multi-tone data of RGB. Next, the process proceeds to step S37. In the step S37, the multi-tone data of RGB after the decoding process is stored in the first RAM 34. Next, the process proceeds to step S38. In the step S38, an image restoring process equal to the steps S21 to S26 in the image restoring process, which is performed in the microcomputer 7 in the first embodiment described above and is shown in FIG. 5, is performed to restore the image f(x, y) having no blur. Next, the process proceeds to step S39. In the step S39, the restored image f(x, y) is stored in the second RAM 34 through the image processing circuit 43 and the memory I/F 44.

Then, the process proceeds to step S40. In the step S40, the restored image f(x, y) stored in the second RAM 34 is supplied to the printer head 34 through the memory I/F 44, the image processing circuit 43, and the head control circuit 42, and ink droplets are discharged from an ink head toward printing paper such that image information is drawn (printed) on the printing paper.

As described above, according to the third embodiment, in the digital camera DC in the first embodiment, image information is stored as a JPEG file in the memory card 30, angular rate data before and after image information that has been imaged is approximated to, for example, a ninth-order polynomial so as to calculate the coefficients a₀ to a₉ and b₀ to b₉ of the polynomial, and the calculated coefficients a₀ to a₉ and b₀ to b₉ of the polynomial are stored as additional information of Exif IFD in the APP1 of the JPEG image file.

Then, the memory card 30 that stores the JPEG image file is taken out from the digital camera DC after completion of photographing, and then the memory card 30 is mounted in the slot 52 of the printer 31.

Then, when JPEG image files stored in the memory card 30 are read and a desired JPEG image file is selected from the read JPEG image files in the CPU 41, the movement from the step S32 to the steps S37 to S40 is made to perform an image restoring process, since the polynomial coefficients a₀ to a₉ and b₀ to b₉ of angular rate data are stored in the selected JPEG image file. In the image restoring process, the image restoration with no blur is performed on the polynomial coefficients a₀ to a₉ and b₀ to b₉, the restored image is stored in the ROM 33, and the restored image that is stored is transmitted to the printer head 35. Thus, a restored image having no blur can be printed.

Even in the third embodiment, angular rate data detected at the time of imaging the image information is expressed by using coefficients of a polynomial so as to be stored in a storage unit. Accordingly, it is possible to greatly reduce required memory capacity and to improve transmission efficiency of angular rate data. Even in the case of adding the angular rate data in the JPEG image file or the like, the angular rate data can be easily added. Further, in the case of hand shaking correction, the order of a polynomial is mostly equal to or smaller than tenth order. Accordingly, since it is sufficient to prepare at least ten memory areas, the angular rate data can be easily added in the JPEG image file. Furthermore, by storing an image file added with coefficients of a polynomial in the memory card 30, data exchange between the digital camera DC and the printer 31 serving as an imaging apparatus can be easily performed.

Furthermore, in the third embodiment, a case has been described in which transmission of image information between the digital camera DC and the printer 31 is performed by using the memory card 30. However, the invention is not so limited. For example, as shown in FIG. 9, image data and the polynomial coefficients a₀ to a_{N} and b₀ to b_{M} stored in the non-volatile memory NM of the digital camera DC may be directly read into the first RAM 32 of the printer 31 by connecting the digital camera DC to the USB host circuit 45 of the printer 31 through the USB code 51.

Furthermore, in the third embodiment, a case has been described in which the same image restoring process as that in the first embodiment is performed. However, the invention is not so limited, but other image restoring methods, such as the image restoring method disclosed in Japanese Patent No. 3152750, may be applied.

In addition, in the third embodiment, a case has been described in which the invention is applied to a printer. However, the invention is not so limited. For example, image information for which hand shaking correction has been performed can be restored to be displayed by applying the invention to a display apparatus, such as a projector or a television, which reproduces the image information.

In addition, in the third embodiment, a case has been described in which the hand shaking correction is performed. However, the invention is not so limited. For example, by detecting, as continuous angular rate data, pan and tilt operations of a digital camera when creating a composite photograph, such as a panoramic photograph, after photographing a landscape or the like with continuous motion of the digital camera, performing polynomial approximation on the detected angular rate data in the same manner as in the hand shaking correction, and storing coefficients of respective orders of a polynomial in a storage unit, it is possible to restore movement traces of a camera made by the pan and tilt operations of the digital camera based on the coefficients of the respective orders of the polynomial stored in the storage unit and to form a composite photograph in which a plurality of photographed image information is accurately composed based on the restored movement traces.

What is claimed is:

1. An imaging apparatus that photographs a subject to obtain digital image information, comprising:
a photographing operation detection unit that detects angular rate data in a photographing operation over a predetermined sampling period;
a polynomial coefficient calculation unit that approximates the angular rate data over each sampling period detected by the photographing operation detection unit to a polynomial and calculates coefficients of the approximated polynomial; and
a coefficient storage unit that stores the coefficients of the polynomial calculated by the polynomial coefficient calculation unit.

2. The imaging apparatus according to claim 1 further comprising:
an image restoring unit that performs correction of the photographing operation based on the coefficients of the polynomial stored in the coefficient storage unit so as to restore an image after the correction.

3. The imaging apparatus according to claim 1,
wherein the photographing operation detection unit includes an angular rate sensor.

4. The imaging apparatus according to claim 3,
wherein the angular rate sensor comprises a gyrosensor.

5. The imaging apparatus according to claim 1,
wherein the polynomial coefficient calculation unit approximates a sampling time and the angular rate data to a polynomial by applying one of:
a least-square method; and
a sequential least-square method
so as to calculate the coefficients of the approximated polynomial.

6. An image processing apparatus comprising:
an imaging apparatus having:
an imaging unit that photographs a subject to obtain digital image information;
a photographing operation detection unit that detects angular rate data in a photographing operation over a predetermined sampling period;
a polynomial coefficient calculation unit that approximates the angular rate data over each sampling period detected by the photographing operation detection unit to a polynomial and calculates coefficients of the approximated polynomial; and
an information storage unit that stores the coefficients of the polynomial calculated by the polynomial coefficient calculation unit together with the digital image information imaged by the imaging unit;
an image restoring unit that performs correction of the photographing operation based on the digital image information and the coefficients of the polynomial stored in the information storage unit of the imaging apparatus so as to restore image information after the correction; and
an image information output unit that outputs the image information restored by the image restoring unit.

7. An image processing apparatus comprising:
an image restoring unit that performs correction of a photographing operation based on digital image information and coefficients of a polynomial stored in an information storage unit so as to restore image information after the correction, the information storage unit being included in an imaging apparatus having:
an imaging unit that photographs a subject to obtain the digital image information;
a photographing operation detection unit that detects angular rate data in the photographing operation over a predetermined sampling period;
a polynomial coefficient calculation unit that approximates the angular rate data over each sampling period detected by the photographing operation detection unit to a polynomial and calculates coefficients of the approximated polynomial; and
the information storage unit that stores the coefficients of the polynomial calculated by the polynomial coefficient calculation unit together with the digital image information imaged by the imaging unit; and
an image information output unit that outputs the image information restored by the image restoring unit.

8. The image processing apparatus according to claim 6,
wherein the photographing operation detection unit includes an angular rate sensor.

9. The image processing apparatus according to claim 8,
wherein the angular rate sensor comprises a gyrosensor.

10. The image processing apparatus according to claim 6,
wherein the polynomial coefficient calculation unit approximates a sampling time and the angular rate data to a polynomial by applying one of:
a least-square method; and
a sequential least-square method
so as to calculate the coefficients of the approximated polynomial.

11. The image processing apparatus according to claim 6,
wherein the information storage unit is configured such that the digital image information is stored in an image file after performing image compression using a JPEG method on the digital image information and the coefficients of the polynomial calculated by the polynomial coefficient calculation unit are added in a header of the image file.

12. The image processing apparatus according to claim 6,
wherein the information storage unit includes a memory card.

13. The image processing apparatus according to claim 6,
wherein the image information output unit includes at least one of a printing apparatus and an image display apparatus.
